(19) United States
(12) Patent Application Publication
(10) Pub. No.: US 2023/0012202 A1
(43) Pub. Date: Jan. 12, 2023

(54) GRAPH COMPUTING OVER MICRO-LEVEL AND MACRO-LEVEL VIEWS

(71) Applicant: INTERNATIONAL BUSINESS MACHINES CORPORATION, Armonk, NY (US)

(72) Inventors: Ci-Hao Wu, Taipei City (TW); June-Ray Lin, Taipei City (TW); Cheng-Ta Lee, Chamblee, GA (US)

(21) Appl. No.: 17/368,627

(22) Filed: Jul. 6, 2021

(51) Int. Cl. G06N 5/04; G06N 7/00; G06F 16/901; G06F 21/56

(52) U.S. Cl. CPC G06N 5/043; G06N 7/005; G06F 16/9024; G06F 21/566; G06F 21/561; G06F 2221/034

(57) ABSTRACT

Graph computing over micro and macro views includes expanding, with a processor at run-time, a set of nodes to include a node generated in response to received data corresponding to an event query. A first inference of an inference ensemble is determined by traversing a base graph whose nodes are associated with a discriminant power that exceeds a predetermined entity threshold. A second inference of the inference ensemble is determined by traversing a micro-view graph whose nodes are selected based on a number of references that exceeds a predetermined reference threshold. A third inference of the inference ensemble is determined by traversing a macro-view graph having one or more committee nodes and computing for each committee node a macro-node vote and generating a response to the event query based on the inference ensemble.

### BACKGROUND

This disclosure relates to computer-implemented systems and processes, and more particularly, to graph computing for probabilistic and inductive inferences.

Graph computing involves the processing of graph data. Such data can be pictorially presented as a graph—that is, as a set of nodes (also called vertices) and edges (also known as links or arcs). The nodes can correspond to real-world observations, events, random variables, and other objects. The edges visually depict characteristics of and relationships between the objects represented by nodes. In a probabilistic model, such as a Bayesian Network or Markovian Random Field, for example, each edge of the graph expresses a probabilistic relationship between variables corresponding to the edge-connected nodes.

In addition to providing a visualization of the structure of an underlying model, graphs can provide insights into conditional independence properties for making inferences, as well as deterministic properties for deductive reasoning. The properties can be discerned by inspection of the graph. Still another advantage is the ability to express complex computations required to perform inference and learning in terms of graphical manipulations, whereby the underlying mathematical manipulations are carried out implicitly. Graph computing is well suited for relational modeling and reasoning in a wide array of diverse fields, from influencer discovery in the context of social networks to detecting cyber threats in the context of data communications networks.

### SUMMARY

In an example implementation, a computer-implemented method includes expanding, with a processor at run-time, a set of nodes to include a node generated in response to received data corresponding to an event query. The method includes determining a first inference of an inference ensemble by traversing a base graph generated by the processor using the set of nodes, wherein the base graph is generated to include nodes selected from the set of nodes that each have associated therewith a discriminant power that exceeds a predetermined entity threshold. The method includes determining a second inference of the inference ensemble by traversing a micro-view graph, wherein the micro-view graph is generated to include nodes selected from the set of nodes that each have associated therewith a number of parent nodes that exceeds a predetermined reference threshold. The method includes determining a third inference of the inference ensemble by traversing a macro-view graph, wherein the macro-view graph contains one or more committee nodes generated from the set of nodes by merging nodes that are edge-connected to a common parent node and selected based on having an associated macro-node vote that exceeds a predetermined value. The method includes generating a response to the event query based on the inference ensemble.

In another example implementation, a system includes a processor configured to initiate operations. The operations include expanding, with a processor at run-time, a set of nodes to include a node generated in response to received data corresponding to an event query. The operations include determining a first inference of an inference ensemble by traversing a base graph generated by the processor using the set of nodes, wherein the base graph is generated to include nodes selected from the set of nodes that each have associated therewith a discriminant power that exceeds a predetermined entity threshold. The operations include determining a second inference of the inference ensemble by traversing a micro-view graph, wherein the micro-view graph is generated to include nodes selected from the set of nodes that each have associated therewith a number of parent nodes that exceeds a predetermined reference threshold. The operations include determining a third inference of the inference ensemble by traversing a macro-view graph, wherein the macro-view graph contains one or more committee nodes generated from the set of nodes by merging nodes that are edge-connected to a common parent node and selected based on having an associated macro-node vote that exceeds a predetermined value. The operations include generating a response to the event query based on the inference ensemble.

In another example implementation, a computer program product includes one or more computer readable storage media, and program instructions collectively stored on the one or more computer readable storage media. The program instructions are executable by computer hardware to initiate operations. The operations include expanding, with a processor at run-time, a set of nodes to include a node generated in response to received data corresponding to an event query. The operations include determining a first inference of an inference ensemble by traversing a base graph generated by the processor using the set of nodes, wherein the base graph is generated to include nodes selected from the set of nodes that each have associated therewith a discriminant power that exceeds a predetermined entity threshold. The operations include determining a second inference of the inference ensemble by traversing a micro-view graph, wherein the micro-view graph is generated to include nodes selected from the set of nodes that each have associated therewith a number of parent nodes that exceeds a predetermined reference threshold. The operations include determining a third inference of the inference ensemble by traversing a macro-view graph, wherein the macro-view graph contains one or more committee nodes generated from the set of nodes by merging nodes that are edge-connected to a common parent node and selected based on having an associated macro-node vote that exceeds a predetermined value. The operations include generating a response to the event query based on the inference ensemble.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 is a block diagram illustrating an example graph computing system.

FIG. 2 is a flow chart illustrating an example process performed using the system of FIG. 1.

FIGS. 3A-3C depict portions of a base-view graph generated by the example computing system illustrated in FIG. 1.

FIGS. 4A-4C depict portions of a micro-view graph generated by the example computing system illustrated in FIG. 1.

FIGS. 5A-5C depict portions of a macro-view graph generated by the example computing system illustrated in FIG. 1.

FIG. 6 is a block diagram illustrating an example cloud computing environment.

FIG. 7 is a block diagram illustrating example abstraction model layers.

FIG. 8 is a block diagram illustrating an example computer hardware system for implementing the system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to computer-implemented systems and processes, and more particularly, to graph computing for performing probabilistic, inductive inferences. An aspect of the systems, methods, and computer program products disclosed herein is enhancement of graph computing using micro-view and macro-view graphs. The graphs provide an intuitively understandable picture of inferential relations between variables representing observed objects and real-world events.

The systems, methods, and computer program products disclosed herein automatically create micro-view and macro-view graphs using data input. The computer-generated micro-view and macro-view graphs can discover dependencies between objects and events. Based on the discovered dependencies, inferences through inductive reasoning are made automatically using the computer-created micro-view and macro-view graphs. The micro-view and macro-view graphs are automatically refined and expanded as new inferences are made in response to new queries based on newly received data. The systems and methodologies disclosed have wide applicability across many fields of endeavor, from defending against cyberattacks to discovering influencers within a social network.

In one arrangement, the inductive reasoning performed with the systems, methods, and computer program products disclosed herein is based on the discriminant power of the learned dependency between objects represented as edge connected nodes. In another arrangement, inductive reasoning is based on reference values corresponding to the number of edge connections between a child node and one or more parents of a computer-generated micro-view graph. In still another arrangement, inductive reasoning is based on probabilities determined by the number of nodes found to be logically related.

The dependencies expressed graphically in the micro-view and macro-view graphs as nodes connected by edges, in some applications, can be based on conditional probabilities. The conditional probabilities allow the joint distribution over K objects (e.g., random variables) given by p(x₁, x₂, . . . , x_{K}), to be expressed by repeated application of the product rule of probabilities as

p(x₁,x₂, . . . , x_{K})=p(x_{K}|x₁,x₂, . . . , x_{K-1}) . . . p(x₂|x₁)p(x₁).

A traversable path from one node to another via one or more intermediate nodes corresponds to dependencies among the nodes (e.g., objects, events, random variables) and a corresponding probability can be assigned to each.

Micro-view and macro-view graph dependencies, however, need not be based on probabilities. Thus, the system and methodologies disclosed herein are also usable for applications in which the determination of probability functions is infeasible or computationally inefficient.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

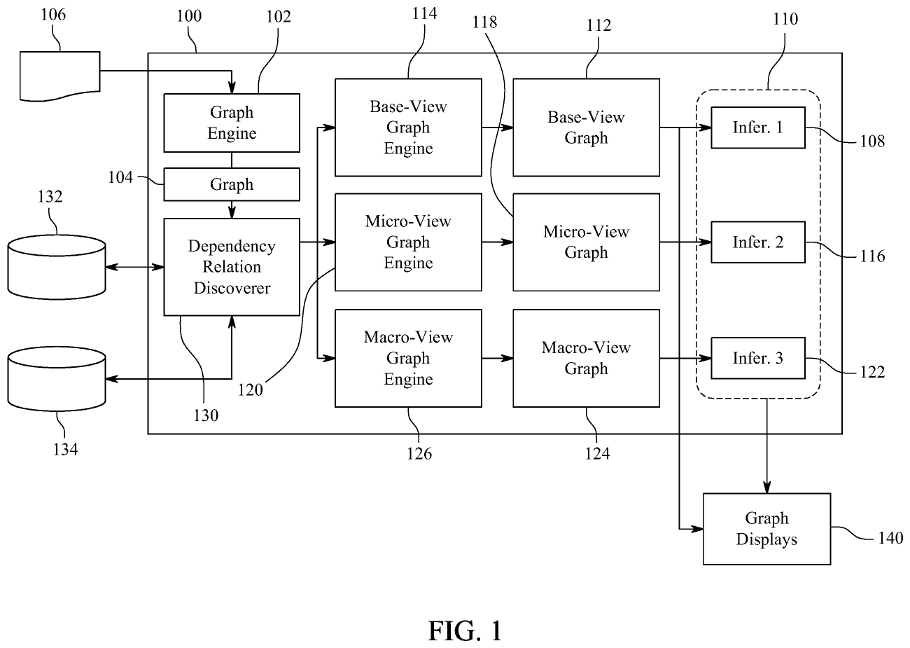

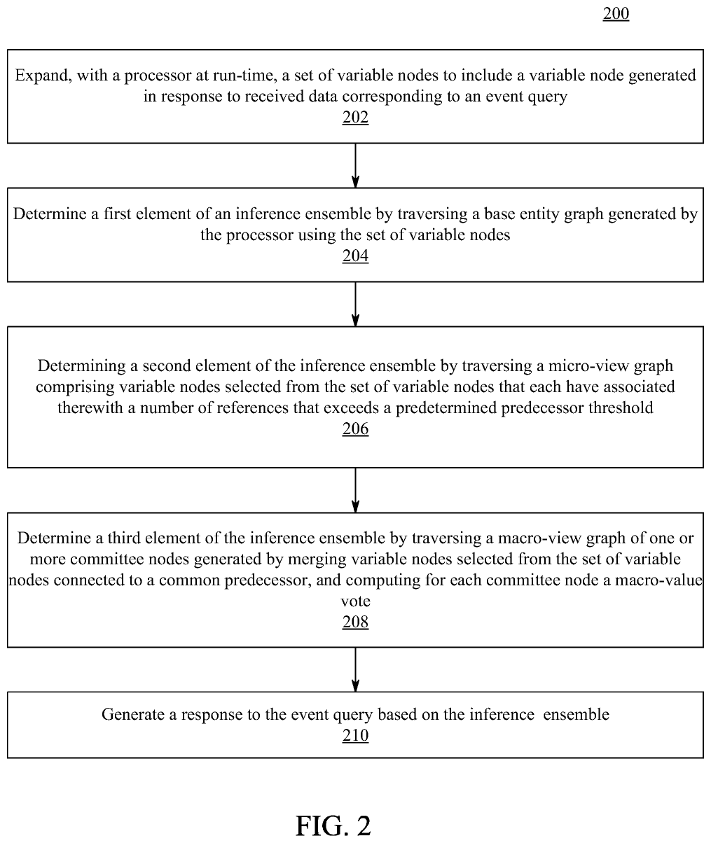

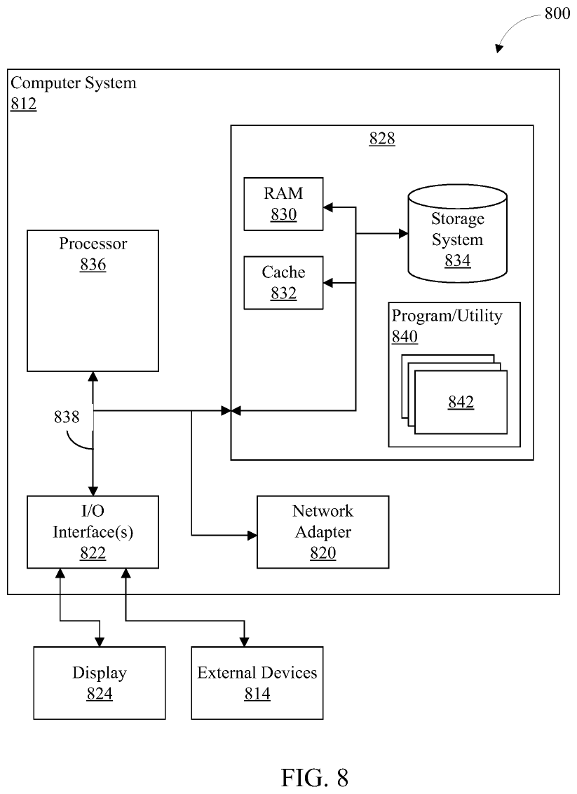

FIGS. 1 and 2, respectively, illustrate example graph computing system (system) 100 and methodology 200 for implementing certain aspects of micro-view and macro-view graph computing. System 100 can be implemented in a computer system such as computer system 812 of computing node 800 described in detail with reference to FIG. 8. More specifically, in certain arrangements, system 100 can be implemented in software electronically stored in a memory such as memory 828 and executed by a processor such as processor 816 of computer system 812 (FIG. 8).

Methodology 200 is illustratively described now in the specific context of graph computing performed by system 100 that in accordance with certain arrangements detects, identifies, and/or recommends protective measures against malicious software attacks on a computer system. In other arrangements, however, the same methodology applies with respect to other scenarios and situations using the micro-view and macro-view graph computing systems and methodologies disclosed herein.

Operatively, at block 202, graph engine 102 expands a set of edge-connected nodes (not explicitly shown) of system-generated graph 104 in response to received data 106 corresponding to an event query. Each node of system-generated graph 104 corresponds to a computer-processable data structure that represents an observable object or event. For example, in the context of detecting and defending against a malicious software attack, an object may be an indicator of compromise (IOC), malicious software file, family of software files, threat actor, or the like. As defined herein, “threat actor” is an entity (individual or organization) that instigates a malicious software attack. An IOC can be a hash of a malicious file, an IP address and/or domain associated with a malicious file, or other such object. An event may be a malicious software attack, whether observed or potential with some probability, or similar such event. The set of nodes is initially generated by graph engine 102 based on known or postulated relationships among objects or events. The set of nodes can be subsequently expanded by adding one or more newly created nodes that correspond to and represent received data 106. An event query, as defined herein, is an instruction to initiate actions performed by system 100 to determine or infer a relationship between the newly created node(s) and one or more other nodes of system-generated graph 104. For example, in the present context, event query 106 is illustratively an instruction to initiate system-performed actions to determine or infer a relationship between one or more newly created nodes representing one or more detected IOCs and one or more malware families likely associated with the one or more IOCs.

Thus, system 100 generates system-generated graph 104 by generating a node for each data structure created to represent in a computer-processable form an observed object (e.g., IOC, malware family, threat actor). In the context of detecting and defending against a malicious software attack, an observed object such as a malicious software file or IOC can be detected by the same computer that implements system 100 or a computer communicatively coupled with the computer that implements system 100.

The nodes of system-generated graph 104 that are related according to some criteria are linked by edges. Two nodes may be related by a dependency in which one node is deterministically or probabilistically dependent on the other. A direct dependency is based on deductive reasoning and directly links two nodes. An inferential dependency is based on inductive reasoning, wherein the inference is drawn from the fact that two nodes, though not directly linked, are nonetheless connected by a traversable path through one or more intermediate nodes.

For example, in the context of detecting and defending against a malicious software attack, a node corresponding to identifying a particular malware family may be inferentially dependent on observing one or more IOCs (e.g., hash). The dependence can be inferential though there is no direct relation between the malware family and one or more IOCs. The inference is discovered if, for example, the malware family is discovered to relate to an observable characteristic that occurs when the one or more IOCs are observed. A node labeled with a detector tag can represent the observable characteristic. The dependencies between the detector tag, the malware family, and one or more IOCs are represented in system-generated graph 104 by edges connecting the respective nodes of each. A traversable path from the node(s) representing one or more IOCs to the malware family node through the intermediate node corresponding to the detector tag establishes a possible relation between the IOC and the malware family. An object of system 100 and methodology 200 is to discover and ascertain the confidence that such a relationship exists.

At block 204, system 100 determines a first inference 108 of an inference ensemble 110. System 100 determines first inference 108 of inference ensemble 110 by traversing base-view graph 112, which is generated by base-view graph engine 114. Base-view graph 112 is a graph of nodes selected from the set of nodes (comprising graph 104). The nodes selected are selected by base-view graph engine 114 determining that each node selected has associated therewith a discriminant power that exceeds a predetermined discriminant threshold.

In some arrangements, discriminant power is based on the number of a node's offspring or children. As defined herein, a “parent node” is a node connected to one or more other nodes by a directed edge, shown graphically as an arrow emanating from the parent node and extending to the one or more other nodes. An “offspring” or “child node,” accordingly, is defined as a node to which a directed edge points. The direction of the arrow indicates an inferential dependency in the sense that the occurrence, existence, or likelihood of the object or event represented by the child node is dependent on or influenced by the presence of the parent node. In those arrangements in which discriminant power is based on the number of a node's offspring or children, a discriminant power can be computed as the inverse of the number of offspring or children of a parent node. This reflects the intuitive notion that the fewer offspring or children a parent node has, the more discriminating the presence of the parent is. For example, the discriminant power of a parent node with only one child is twice that of a parent node having two children. By reflecting discriminant power, base-view graph 112 refines and enhances the inferential reasoning as compared to system-generated graph 104. In certain arrangements, child nodes can comprise a defined class (e.g., nodes labeled by detector tags) and parent nodes can comprise a different defined class (e.g., detected IOCs).

In other arrangements, a discriminant power, NDP, is defined in terms of sensitivity and specificity for evaluating prediction accuracy. As defined, NDP≡(\sqrt{3}/_{π})*(log X+log Y), where X≡[/sensitity/_{(1-sensitivity)}] and Y≡[specificity/_{(1-specificity)}]. Sensitivity is defined as tp/_{(tp+fn)}, wherein tp is a true positive and fn is a false negative. Specificity is defined as tn/_{(tn+fp)}, wherein tn is a true negative and fp is a false positive. “Positive” denotes a prediction that a predefined event occurs or relationships exists. It is “true positive” if as predicted the event does occur or the relationships do in fact exist. It is “false positive” if in fact the event does not occur or the relationships do not exist, notwithstanding the contrary prediction. “Negative” denotes a prediction that an event does not occur or that relationships do not exist. It is a “true negative” if as predicted the event in fact does not occur or the relationships do not exist. It is a “false negative” if despite the contrary prediction the event in fact does occur or the relationship does exist. In the present context, for example, assume a malware family node can reach p out of n threat actors, however, only one of the p is in fact a threat actor related to the malware (true positive). Then it follows that tp=1, fp=p-1, and tn+fn=n-p. If, however, there are indeed p threat actors related to the malware family, then fn=fp (the malware family node should be edge connected with the other p-1 threat actors).

At block 206, system 100 determines a second inference 116 of inference ensemble 110. System 100 determines second inference 116 of inference ensemble 110 by traversing micro-view graph 118, which is generated by micro-view graph engine 120. Micro-view graph 118 is a graph of nodes that are selected from the set of nodes (graph 104), wherein each node selected is selected based micro-view graph engine 120 determining the number of parents of the node exceeds a predetermined reference threshold.

At block 208, system 100 determines a third inference 122 of inference ensemble 110. System 100 determines third inference 122 by traversing macro-view graph 124, which is generated by macro-view graph engine 126, and by computing for each committee node a macro-node vote. Each committee node of macro-view graph 124 is generated by merging nodes that are edge-connected to a common predecessor (parent node). Accordingly, as defined herein, a “committee node” is a grouping of two or more nodes that are edge-connected to the same parent node. Macro-view graph 124 can be implemented as a probabilistic graph model. Macro-view graph 124, as generated by macro-view graph engine 126, comprises those committee nodes whose associated macro-node vote exceeds a predetermined value. The macro-node vote of each committee node can be determined based on a weighted probability that the committee node is edge-connected to a predetermined target node. In the context of detecting and defending against a malicious software attack, a target node can correspond to a malware family and/or a threat actor. In certain arrangements, the weight applied in determining the macro-value vote is computed as the product of the number of nodes merged into a committee node times a macro-node vote multiplier, which is a predetermined value between zero and one.

In the context of detecting and defending against a malicious software attack, for example, there can be two malware families, one represented by x.y.z and the other represented by p.q.r, which have a common parent. Merging the malware family nodes generates a committee node comprising node x.y.z and node p.q.r. The committee node, for example, can connect via an edge to threat actor APTl. A committee node is a stronger node in the sense of greater certainty regarding a relational dependency compared to individual node x.y.z and individual node p.q.r, each viewed singly as indicating a relational dependency with APTl. The committee node indicates node x.y.z and node p.q.r both imply a relational dependency with APTl. A discriminant power (e.g., NDP) can be associated with each committee node, calculated at the macro level among all committee nodes. Given a committee node is stronger than individual nodes, the value of a macro-node vote can be multiplied by the number of individual nodes merged into the committee node. Thus, for the committee node that merges individual node x.y.z and individual node p.q.r, the macro-node vote is multiplied by 2, indicating that threat actor APTl can be reached from either node x.y.z or node p.q.r, immediately providing two votes. Individually, nodes x.y.z and p.q.r are not necessarily weighted equally. Node x.y.z can be weaker than that of node p.q.r or vice versa. Therefore a macro-node vote multiplier (a number between 0 and 1) is introduced to weaken the vote value and a path traversal through the committee node comprising nodes x.y.z and p.q.r to the APTl node may garner only 2*0.7=1.4 votes. The value 0.7 is a predetermined value indicating how strong each individual vote (“x.y.z” or “p.q.r”) could be. It can be calculated from a general discriminant power (e.g., NDP) the appropriate nodes. The value 0.7 can be a predetermined constant indicating that roughly 7 out of 10 nodes have a specific discriminant power (e.g., NDP). For computational efficiency, the same multiplier can be used with respect to each committee node. The final vote for each, however, can differ given that different committee nodes may combine different numbers of nodes.

At block 210, a response to the event query is generated. The response is based on the inference ensemble. The inference ensemble comprises first inference 108, second inference 116, and third inferences 122 determined, respectively, by traversing base-view graph 112, micro-view graph 119, and macro-view graph 124. In certain embodiments, the response is determined by a type of “majority vote,” in which if two or more traversals lead to the same node, then that node is deemed the reliable response. For example, in the context of detecting and defending against a malicious software attack, the process may yield traversable paths extending from a node corresponding to an IOC to a node representing a malware family and/or threat actor. If two or more of the traversable paths lead to the same node, system 100 deems the inference reliable that the IOC is logically linked to the malware family or threat actor represented by the node. In other arrangements, sums of discriminant powers along a traversable path of base-view graph 112, and of reference values along a traversable path of micro-view graph 119, and of macro-node votes along a traversable path of macro-view graph 124 can be computed. The response to query can be determined by choosing the end node (e.g., malware family or threat actor) of the traversable path for which the computed sum is greatest. Again, in the context of detecting and defending against a malicious software attack, system 100 optionally can generate a recommendation to guard against attacks based on the malware family or threat actor identified.

Again, in the specific context of detecting and defending against a malicious software attack, three distinct calculations can be performed by system 100 in determining whether relationships pertaining to two distinct malware families, x.y.z and p.q.r, edge-connected with threat actor APTx may implicate a cyberattack involving APTx, for example. Firstly, a discriminant power (e.g., NDP) can be calculated for x.y.z and p.q.r individually to determine whether alone one or the other is sufficiently related to establish with reliable certainty APTx's involvement. Secondly, the discriminant power combined with reference values along a traversable path of a micro-view graph can be determined to assess whether alone one or the other, x.y.z or p.q.r, is sufficiently related to establish with reliable certainty APTx's involvement. And thirdly, the discriminant power-based assessment can be combined with determining macro-node vote values to determine whether a relationship based on a committee node comprising x.y.z and p.q.r is sufficiently strong to imply the involvement of APTx. For discriminant power-based determinations, if the discriminant power is greater than a predetermined threshold (e.g., NDP>2.5), a certain inference (e.g., +1) indicates APTx's involvement. However, with respect to the micro view, an inference of involvement requires discriminant power greater than a threshold (e.g., NDP>2.5). And for the macro view, the inference of involvement requires a greater-than-threshold discriminant power as well as a number of parent nodes (references) greater than a predetermined threshold (e.g., references>30) for an inference (e.g., +1) indicating APTx's involvement. System 100 can perform the first procedure first. If no reliable inference is obtained. System 100 can execute the second. If no reliable inference is obtained from the second procedure, then system 100 can perform the third. If no one of the procedures yields a reliable inference, the respective scores generated by two and/or all three of the procedure can be averaged to assess whether there is a relationship establishing APTx's involvement.

Optionally, in the context of detecting and defending against a malicious software attack, system 100 can further include dependency relation discoverer 130, which ascertains relational dependencies between IOCs and characteristics based on which the detector tags are generated. Based on the relational dependencies, graph engine 102 can generate an initial set of edge-connected nodes. The set of nodes can be subsequently expanded by adding one or more newly created nodes in response to relation dependency discover 130 received data input corresponding to newly observed objects (e.g., IOC, malware family, threat actor). Dependency relation discoverer 130 can consult communicatively coupled database 132, which electronically stores data structures (e.g., lists) linking objects (e.g., IOCs) with observed characteristics. Similarly, dependency relation discoverer 130 can consult communicatively coupled database 134, which electronically stores data structures (e.g., lists) linking the characteristics with other objects (e.g., malware families and/or threat actors). Thus, by detecting one or more attributes of each object (e.g., IOC), graph engine 102 can generate a node (e.g., detector tag) for each of the attributes, each detector tag represented as a child node of the node whose data structure represents the object having the attribute corresponding to the node (e.g., detector tag). Based on discovering one or more relational dependencies between one or more objects (e.g., IOCs) and one or more of the nodes and child nodes, each relational dependency can be represented by an edge.

Base-view graph 112, micro-view graph 119, and macro-view graph 124 can be presented visually as graph displays 140 on a display device such as display 824 of computer system 812 (FIG. 8). While each of base-view graph 112, micro-view graph 119, and macro-view graph 124 can be maintained as data structures in electronic memory and used in performing the system actions described, in another aspect, the graphs also can be presented to a user via a display using a graphical user interface (GUI). In other arrangements, however, the graphs are maintained as data structures for performing the system actions described but are not visually presented.

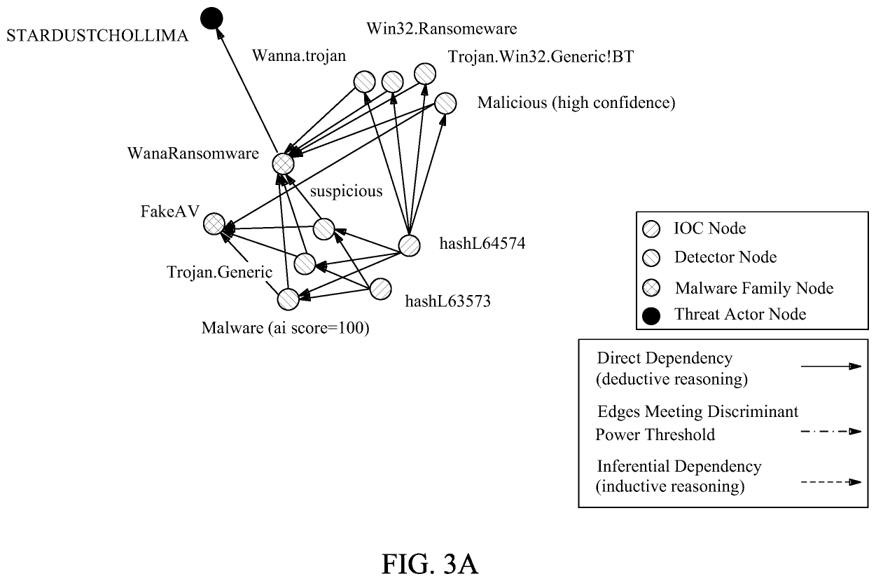

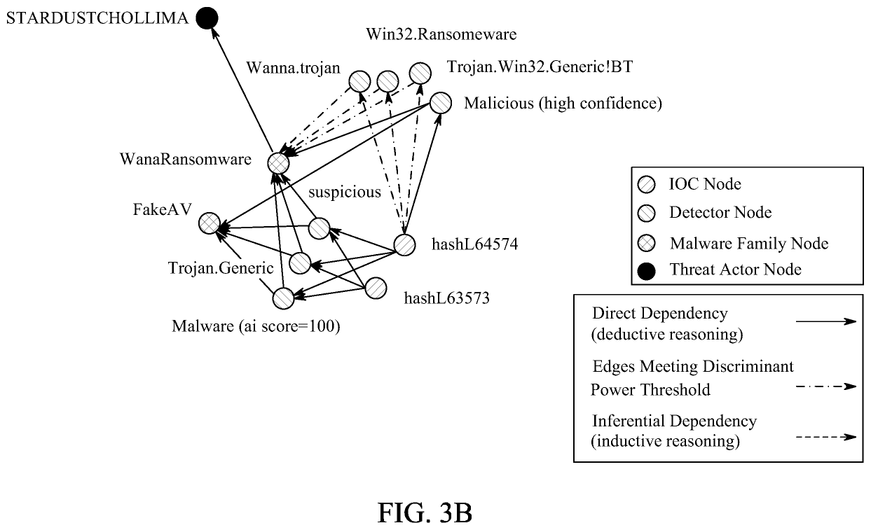

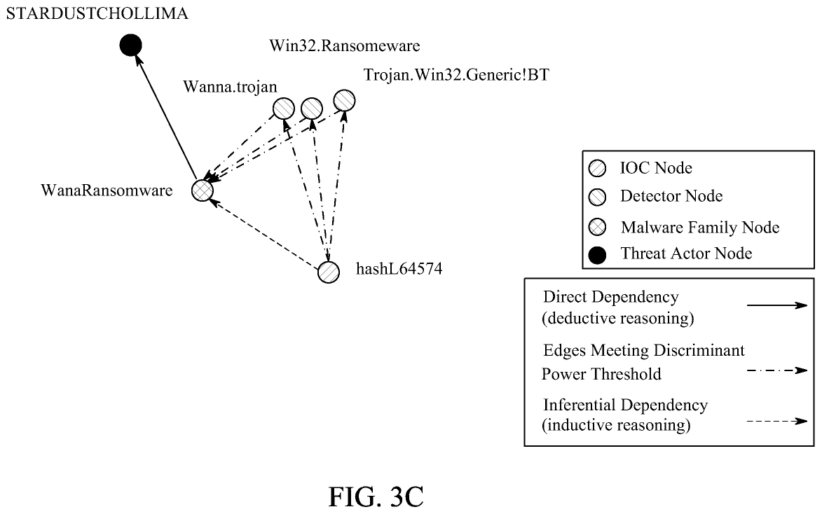

FIGS. 3A-3C are portions of graphs generated in response to the operations performed by entity-view graph engine 114. Initially, as shown in FIG. 3A, the set of nodes of the graph includes two nodes representing IOCs, hashL64574 and hashL63573. Based on the above-described procedures, relational dependencies are discovered linking hashL 6474 and detector tags Wanna.trojan, Win32.Ransomeware, Trojan.Win.32. GenericIBT, Malicious (high confidence), suspicious, Trojan.Generic, and Malware (ai score=100). The relational dependencies are indicated visually by the edges (directed arrows) between the node labeled hashL64574 and the nodes corresponding to the detector tags. Likewise, relational dependencies discovered between the IOC represented by the node labeled hashL63573 and detector tags represented by nodes labeled suspicious, Trojan.Generic, and Malware (ai score=100) are visually displayed by the corresponding edge connections shown. It is worth emphasizing that only a portion of the system-generated graph is shown and that the graph can include numerous other nodes and edges.

The graph as displayed also indicates relational dependencies between nodes labeled by detector tags and nodes corresponding to identified malware families. The relational dependencies, in certain arrangements, can be derived from data electronically stored in one or more databases and linking various threat actors, malware families, and IOCs. The relational dependencies are specified by edge connections between nodes. Edge connections between the node labeled WanaRansomware, corresponding to an identified malware family, and the IOC nodes labeled Wanna.trojan, Win32.Ransomeware, Trojan.Win.32.GenericIBT indicate relational dependencies between the malware family and the three IOCs. The IOC represented by the node labeled hashL63573 shows relational dependencies with two distinct malware families, WanaRansomware and FakeAV, indicated visually by the edge connections shown between the IOC node and the malware family nodes.

Entity-view graph engine 114 determines the discriminant power of each edge. As described above, discriminant power in some arrangements is inversely related to the number of edges between a parent node and its offspring. The IOC nodes labeled Malicious (high confidence), suspicious, Trojan. Generic, and Malware (ai score=100) each have relational dependencies to two different malware families as indicated in the graph by two edges from each to the two malware families. Thus, in arrangements in which the discriminant power is 1/ₙ, where n is the number of edges, the discriminant power of the edge connections of IOC nodes Malicious (high confidence), suspicious, Trojan.Generic, and Malware (ai score=100) is ½. The discriminant power of the edge connections of IOC nodes Wanna.trojan, Win32.Ransomeware, Trojan. Win.32.GenericIBT is one, indicating that the IOC nodes have twice the discriminant power.

If the discriminant power threshold given the current context of detecting and defending against a malicious software attack in which the discriminant power is one over the number of child nodes of a parent, then entity-view graph engine 114 identifies the edge connections between IOC nodes Wanna.trojan, Win32.Ransomeware, Trojan.Win. 32. GenericIBT and malware family node WanaRansomware as satisfying the threshold. Visually, the identification is shown by the dashed lines in FIG. 3B.

Based on the discriminant power of each of the edges, entity-view graph engine 114 prunes the graph of edge-connected nodes that fail to meet the threshold. Base graph 112 is generated by purging the remaining edges and edge-connected nodes. The solid edges connecting IOC node hashL64574 to malware family node WanaRansomware and malware family node WanaRansomware to target node STARDUSTCHOLLIMA indicates a reliable inference that detection of IOC hashL64574 is likely due to a malicious attack instigated by the entity (individual or organization) STARDUSTCHOLLIMA. A system-generated visual image of the base graph is shown in FIG. 3C.

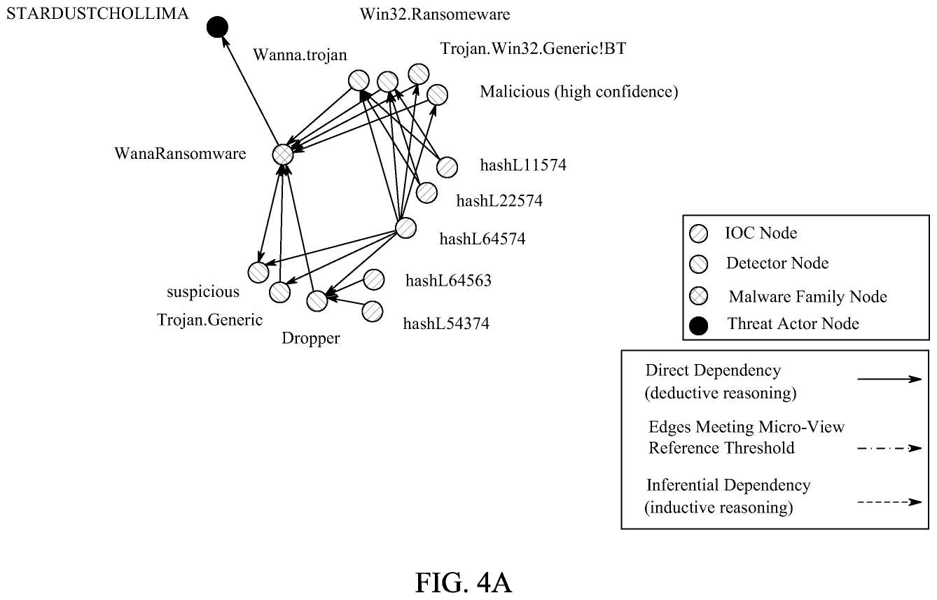

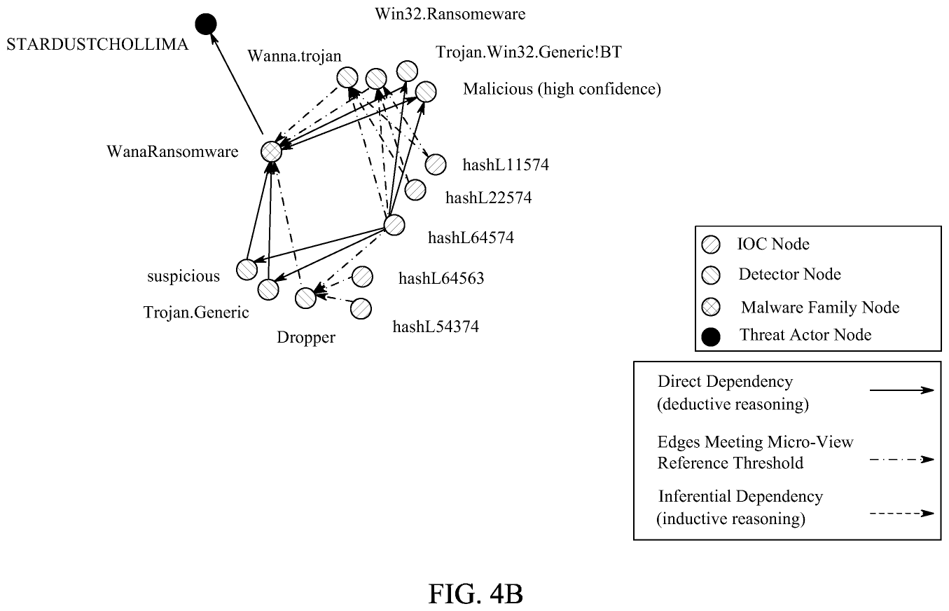

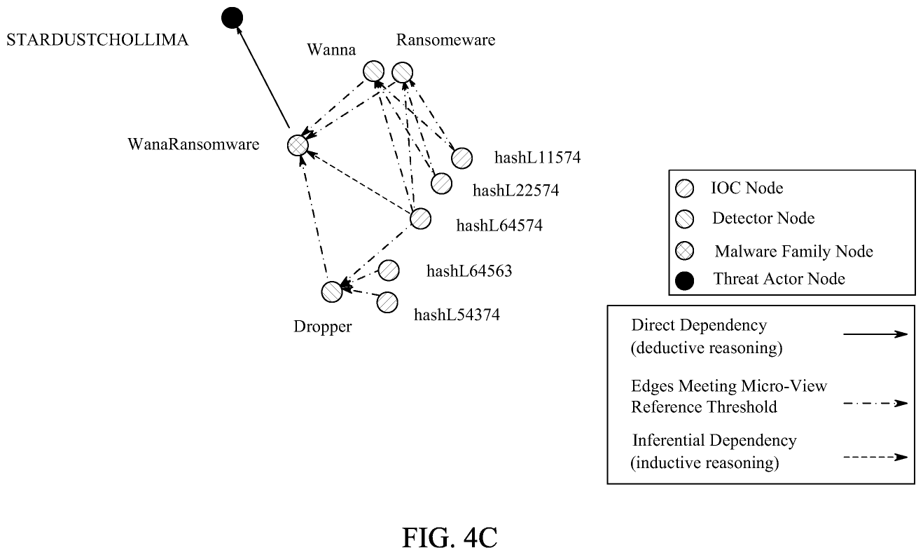

FIGS. 4A-4C are portions of graphs generated in response to the operations performed by micro-view graph engine 120. Again, in the context of detecting and defending against a malicious software attack, the graphical display in FIG. 4A includes the set of nodes representing IOCs, hashL6474 and hashL63573, and detector tags represented by the nodes labeled Wanna.trojan, Win32.Ransomeware, Trojan.Win.32.GenericIBT, Malicious (high confidence), suspicious, Trojan.Generic, and Malware (ai score=100) with the relational dependencies between the nodes shown as described above. The edge connections also show the same relational dependencies between the detector tags and identified malware families WanaRansomware.

Micro-view graph engine 120 determines a reference value for each of the detector tags represented by the nodes labeled Wanna.trojan,Win32.Ransomeware, Trojan.Win.32. GenericIBT, Malicious (high confidence), suspicious, Trojan.Generic, and Malware (ai score=100). The references values are determined based on the number of references associated with each of the detector tag nodes. Micro-view graph engine 120 selects nodes whose reference value is greater than a predetermined threshold. Illustratively, the threshold is one and thus micro-view graph engine 120 selects the nodes labeled Wanna.trojan, Win32.Ransomeware, Trojan.Win.32.GenericIBT, and dropper as the detector nodes. The dashed lines of the visual display shown in FIG. 4B indicate the edge connections between the selected nodes and their respective references.

Micro-view graph engine 120 generates micro-view graph shown in FIG. 4C by pruning the remaining edge-connected nodes.

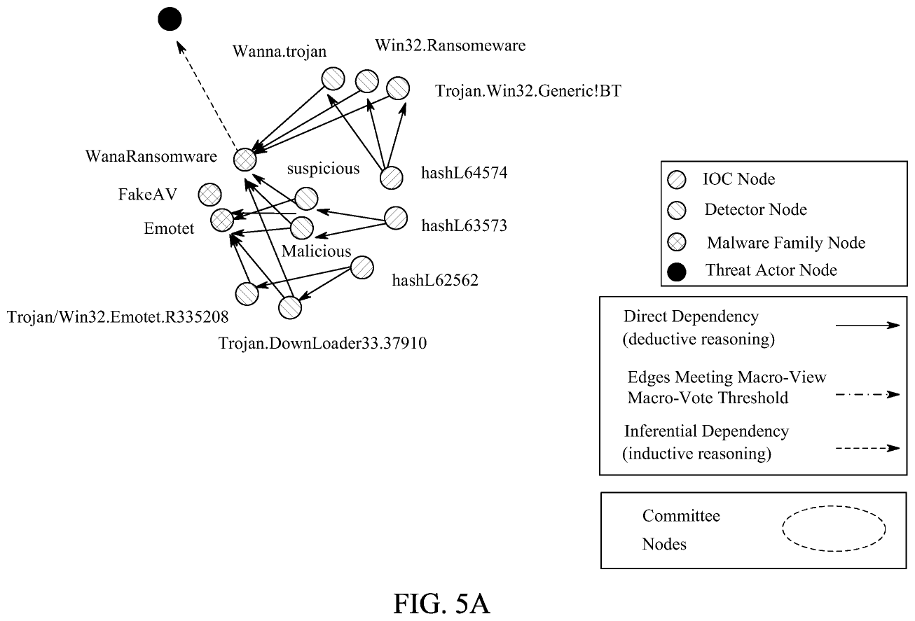

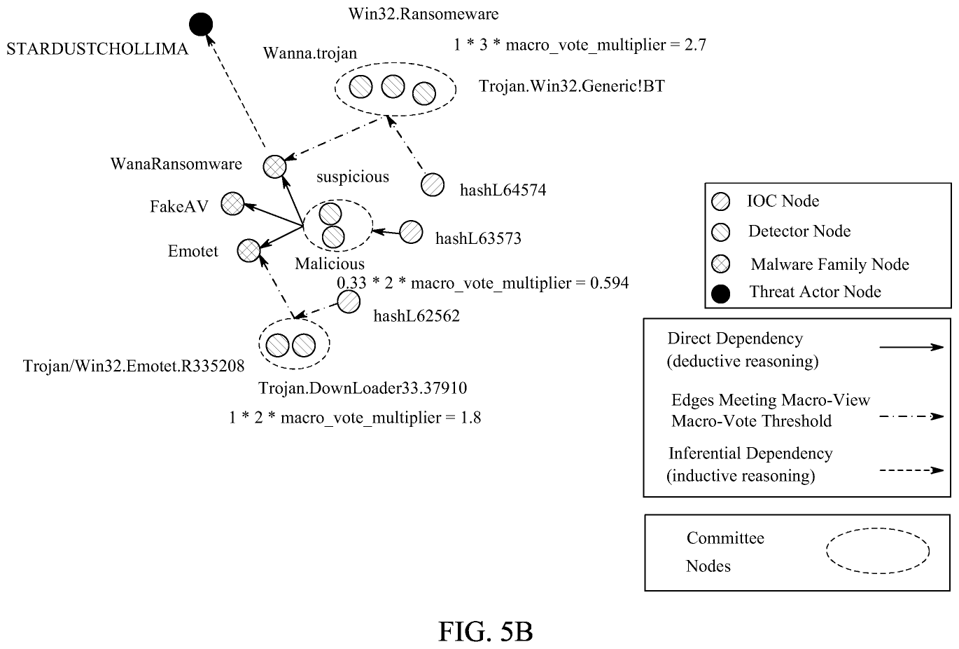

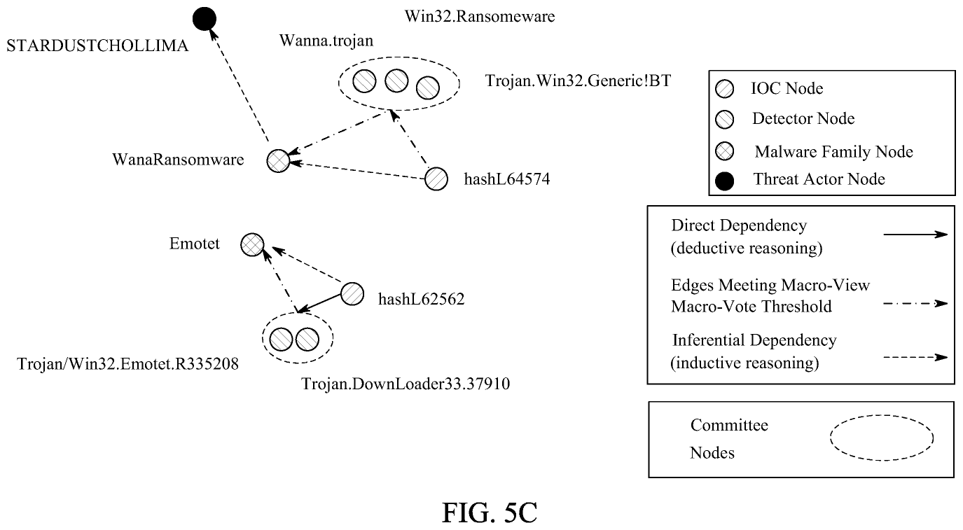

FIGS. 5A-5C are portions of graphs generated in response to the operations performed by macro-view graph engine 126. FIG. 5A includes three IOC nodes labeled hashL64574, hashL63573, and hashL62562; seven detector tag nodes labeled Wanna.trojan, Win32.Ransomeware, Trojan.Win23.GenericIBT, suspicious, malicious, Trojan.Win32.Emtet.R335208, and Trojan.Downloader33.37910; and three malware family nodes labeled Wannaransomware, FakeAV, and Emotet.

As illustrated in FIG. 5B, macro-view graph engine 126 creates three committee nodes based on the node's common predecessors (parents). One committee node is a merger of detector tag nodes Wanna.trojan, Win32.Ransomeware, Trojan.Win23.GenericIBT, which share the common predecessor, IOC node hashL64574. Another committee node created by macro-view graph engine 126 is a merger of detector tag nodes suspicious and malicious, which share the common predecessor, IOC node hashL63573. The other committee node created by macro-view graph engine 126 is a merger of detector tag nodes Trojan/Win32.Emtet.R335208 and Trojan.Downloader33.37910, which share the common predecessor IOC node hashL62562.

Macro-view graph engine 126 computes macro-vote values for each committee node. The committee node created by merging Wanna.trojan, Win32.Ransomeware, and Trojan.Win23.GenericIBT has one child and comprises three nodes. Applying a weight of 0.9, yields a macro-vote value of 1*3*0.9=2.7, which is superimposed on the graph. The committee node created by merging suspicious and malicious, which each have two offspring (malware nodes FakeAV and Emotet), comprises two nodes. The macro-vote value is 0.954, also superimposed on the graph. The other committee node comprises two nodes that each have a single child. The macro-vote value superimposed on the graph is 1.8. Setting a threshold macro-vote value at one, results in macro-view engine 126 purging the committee node comprising suspicious and malicious, as well as their common predecessor and child node FakeAV. Etomet is retained by virtue of being a child of the committee node comprising detector tag nodes Trojan/Win32.Emtet.R335208 and Trojan.Downloader33.37910. The visual graph that results from the pruning by macro-view engine 126 is shown in FIG. 5C. As shown in FIG. 5C, the result of the inferential reasoning links malware family Wannaransomware to IOC hashL6474 and malware family Emotet to IOC hashL62562.

The operations of system 100 have thus been described in the context of detecting and defending against a malicious software attack. The operations of system 100 can be performed in various other contexts for determining or inferring relationships between nodes representing different classes of events. For example, the operations of system 100 can be performed to determine influencers in a social network. The operations of system 100 can performed to identify an actor based on social website IDs, for example. The operations of system 100, for example, can be performed to identify a user based on on-line activities. Based on the arrangements described it will be apparent to one of ordinary skill that the systems and methodologies described can be applied in other contexts as well.

It is expressly noted that although this disclosure includes a detailed description on cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

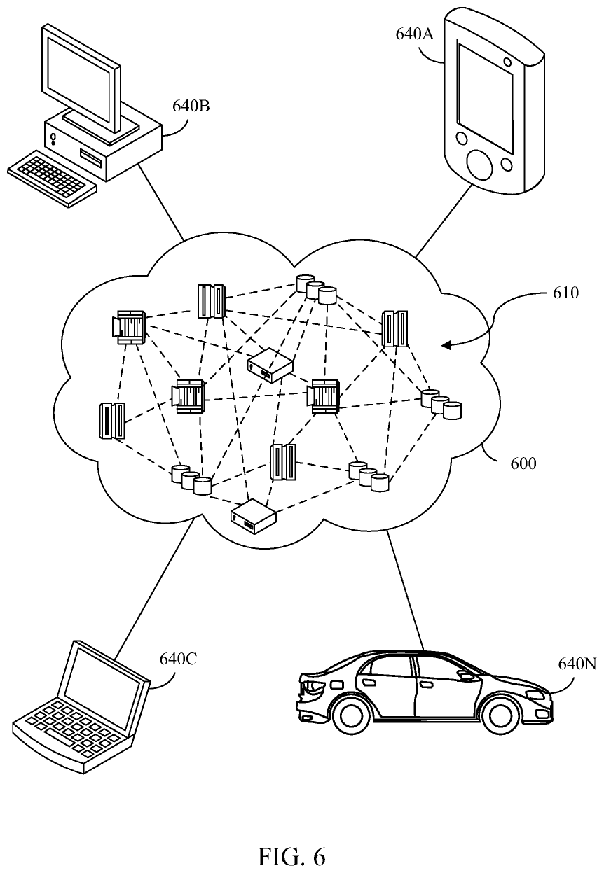

Referring now to FIG. 6, illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 640a, desktop computer 640b, laptop computer 640c, and/or automobile computer system 640n may communicate. Computing nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 640a-n shown in FIG. 6 are intended to be illustrative only and that computing nodes 610 and cloud computing environment 600 can communicate with any type of computerized device over any type of network and/or network addressable connection (e.g., using a web browser).

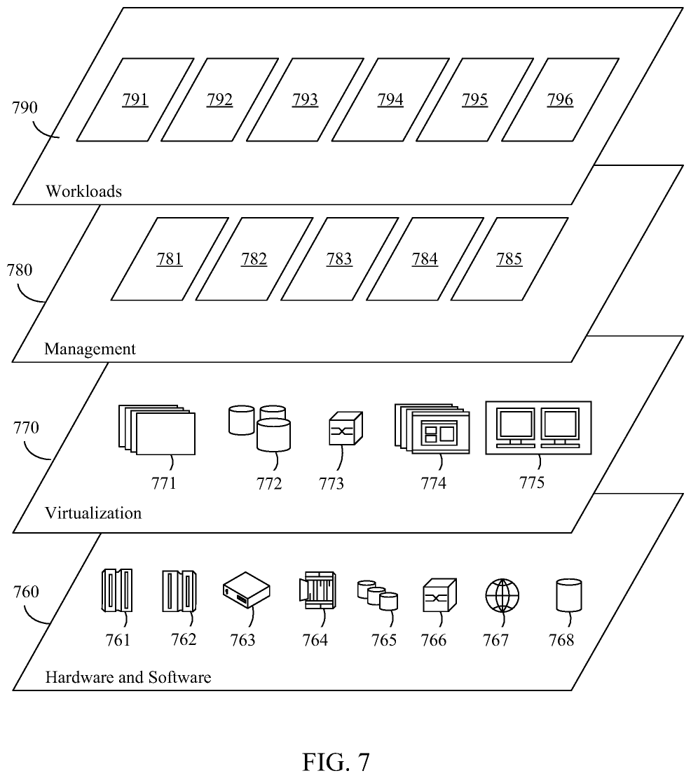

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include mainframes 761; RISC (Reduced Instruction Set Computer) architecture-based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and graph computing system 796.

FIG. 8 illustrates a schematic of an example of a computing node 800. In one or more embodiments, computing node 800 is an example of a suitable cloud computing node. Computing node 800 is not intended to suggest any limitation as to the scope of use or functionality of embodiments of the invention described herein. Computing node 800 is capable of performing any of the functionality described within this disclosure.

Computing node 800 includes a computer system 812, which is operational with numerous other general-purpose or special-purpose computing system environments or configurations. Examples of well-known computing systems, environments, and/or configurations that may be suitable for use with computer system 812 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 812 may be described in the general context of computer system-executable instructions, such as program modules, being executed by a computer system. Generally, program modules may include routines, programs, objects, components, logic, data structures, and so on that perform particular tasks or implement particular abstract data types. Computer system 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system 812 is shown in the form of a general-purpose computing device. The components of computer system 812 may include, but are not limited to, one or more processors 816, a memory 828, and a bus 818 that couples various system components including memory 828 to processor 816. As defined herein, “processor” means at least one hardware circuit configured to carry out instructions. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

The carrying out of instructions of a computer program by a processor comprises executing or running the program. As defined herein, “run” and “execute” comprise a series of actions or events performed by the processor in accordance with one or more machine-readable instructions. “Running” and “executing,” as defined herein refer to the active performing of actions or events by the processor. The terms run, running, execute, and executing are used synonymously herein.

Bus 818 represents one or more of any of several types of bus structures, including a memory bus or memory controller, a peripheral bus, an accelerated graphics port, and a processor or local bus using any of a variety of bus architectures. By way of example only, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and PCI Express (PCIe) bus.

Computer system 812 typically includes a variety of computer system-readable media. Such media may be any available media that is accessible by computer system 812, and may include both volatile and non-volatile media, removable and non-removable media.

Memory 828 may include computer system readable media in the form of volatile memory, such as random-access memory (RAM) 830 and/or cache memory 832. Computer system 812 may further include other removable/non-removable, volatile/non-volatile computer system storage media. By way of example, storage system 834 can be provided for reading from and writing to a non-removable, non-volatile magnetic media and/or solid-state drive(s) (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the invention.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the invention as described herein. For example, one or more of the program modules may include system 796 or portions thereof.

Program/utility 840 is executable by processor 816. Program/utility 840 and any data items used, generated, and/or operated upon by computer system 812 are functional data structures that impart functionality when employed by computer system 812. As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor.

Computer system 812 may also communicate with one or more external devices 814 such as a keyboard, a pointing device, a display 824, etc.; one or more devices that enable a user to interact with computer system 812; and/or any devices (e.g., network card, modem, etc.) that enable computer system 812 to communicate with one or more other computing devices. Such communication can occur via input/output (I/O) interfaces 822. Still, computer system 812 can communicate with one or more networks such as a local area network (LAN), a general wide area network (WAN), and/or a public network (e.g., the Internet) via network adapter 820. As depicted, network adapter 820 communicates with the other components of computer system 812 via bus 818. It should be understood that although not shown, other hardware and/or software components could be used in conjunction with computer system 812. Examples, include, but are not limited to: microcode, device drivers, redundant processing units, external disk drive arrays, RAID systems, tape drives, and data archival storage systems, etc.

While computing node 800 is used to illustrate an example of a cloud computing node, it should be appreciated that a computer system using an architecture the same as or similar to that described in connection with FIG. 8 may be used in a non-cloud computing implementation to perform the various operations described herein. In this regard, the example embodiments described herein are not intended to be limited to a cloud computing environment. Computing node 800 is an example of a data processing system. As defined herein, “data processing system” means one or more hardware systems configured to process data, each hardware system including at least one processor programmed to initiate operations and memory.

Computing node 800 is an example of computer hardware. Computing node 800 may include fewer components than shown or additional components not illustrated in FIG. 8 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

Computing node 800 is also an example of a server. As defined herein, “server” means a data processing system configured to share services with one or more other data processing systems. As defined herein, “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. In one or more embodiments, the various user devices described herein may be client devices. Network infrastructure, such as routers, firewalls, switches, access points and the like, are not client devices as the term “client device” is defined herein.

The terminology used herein is for the purpose of describing particular embodiments only and is not intended to be limiting. Notwithstanding, several definitions that apply throughout this document now will be presented.

As defined herein, the singular forms “a,” “an,” and “the” include the plural forms as well, unless the context clearly indicates otherwise.

As defined herein, “another” means at least a second or more.

As defined herein, “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, “automatically” means without user intervention.

As defined herein, “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, “if” means “in response to” or “responsive to,” depending upon the context. Thus, the phrase “if it is determined” may be construed to mean “in response to determining” or “responsive to determining” depending on the context. Likewise the phrase “if [a stated condition or event] is detected” may be construed to mean “upon detecting [the stated condition or event]” or “in response to detecting [the stated condition or event]” or “responsive to detecting [the stated condition or event]” depending on the context.

As defined herein, “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the phrases “in response to” and “responsive to” mean responding or reacting readily to an action or event. Thus, if a second action is performed “in response to” or “responsive to” a first action, there is a causal relationship between an occurrence of the first action and an occurrence of the second action. The phrases “in response to” and “responsive to” indicate the causal relationship.

As defined herein, “run time” means the phase of a computer program in which the program is run or executed on a computer system.

As defined herein, “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented process, comprising:
expanding, with a processor at run-time, a set of nodes to include a node generated in response to received data corresponding to an event query;
determining a first inference of an inference ensemble by traversing a base graph generated by the processor using the set of nodes, wherein the base graph is generated to include nodes selected from the set of nodes that each have associated therewith a discriminant power that exceeds a predetermined entity threshold;
determining a second inference of the inference ensemble by traversing a micro-view graph, wherein the micro-view graph is generated to include nodes selected from the set of nodes that each have associated therewith a number of parent nodes that exceeds a predetermined reference threshold;
determining a third inference of the inference ensemble by traversing a macro-view graph, wherein the macro-view graph contains one or more committee nodes generated from the set of nodes by merging nodes that are edge-connected to a common parent node and selected based on having an associated macro-node vote that exceeds a predetermined value; and
generating a response to the event query based on the inference ensemble.

2. The computer-implemented process of claim 1, wherein the discriminant power of each node is inversely related to a count of child nodes edge-connected to each node.

3. The computer-implemented process of claim 1, wherein each parent node belongs to a predefined class and each child node belongs to a different predefined class.

4. The computer-implemented process of claim 1, wherein the macro-view graph is a probabilistic graph model and wherein the macro-node vote of each committee node is determined based on a weighted probability that the committee node is edge-connected to a predetermined target node.

5. The computer-implemented process of claim 1, wherein the received data is one or more indicators of compromise (IoC) associated with a malware attack and the event query is based on the one or more indicators of compromise (IoC).

6. The computer-implemented process of claim 5, wherein the response is an identifier identifying a likely malware family associated with the one or more IoCs.

7. The computer-implemented process of claim 5, and wherein the response is an identifier identifying a likely threat actor that instigated the malware attack.

8. The computer-implemented process of claim 5, wherein the response is a recommendation that a computer system be defended against one or more malware families associated with a malicious file corresponding to the one or more IoCs.

9. A computer-implemented process, comprising:
generating a graph having a node for each of a plurality of electronically generated data structures, wherein the data structures represent objects;
detecting one or more attributes of each object and generating a detector tag for each of the attributes, each detector tag represented as a child node of the node whose data structure represents the object having the attribute corresponding to the detector tag;
discovering one or more relational dependencies between one or more objects and one or more of the nodes and child nodes, each relational dependency represented by an edge;
determining a discriminant power corresponding to each edge and generating a base-view graph by pruning the graph of each child node for which the corresponding edge is less than a predetermined threshold;
determining a reference value for each child node and generating a micro-view graph by pruning the graph of each child node whose reference value is less than a predetermined value; and
generating one or more committee nodes by combining child nodes that are edge-connected to the same node, determining a macro-node vote for each committee node, and generating a macro-view graph by pruning the committee nodes whose macro-node vote is less than a predetermined threshold.

10. The computer-implemented process of claim 9, wherein the discriminant power is inversely related to a count of child nodes edge-connected to each node.

11. The computer-implemented process of claim 9, wherein the macro-view graph is a probabilistic graph model and wherein the macro-node vote of each committee node is determined based on a weighted probability that the committee node is edge-connected to a predetermined target node.

12. The computer-implemented process of claim 9, wherein the objects include one or more indicators of compromise (IoC) associated with a malware attack.

13. A system, comprising:
a processor configured to initiate operations including:
expanding, with a processor at run-time, a set of nodes to include a node generated in response to received data corresponding to an event query;
determining a first inference of an inference ensemble by traversing a base graph generated by the processor using the set of nodes, wherein the base graph is generated to include nodes selected from the set of nodes that each have associated therewith a discriminant power that exceeds a predetermined entity threshold;
determining a second inference of the inference ensemble by traversing a micro-view graph, wherein the micro-view graph is generated to include nodes selected from the set of nodes that each have associated therewith a number of parent nodes that exceeds a predetermined reference threshold;
determining a third inference of the inference ensemble by traversing a macro-view graph, wherein the macro-view graph contains one or more committee nodes generated from the set of nodes by merging nodes that are edge-connected to a common parent node and selected based on having an associated macro-node vote that exceeds a predetermined value; and
generating a response to the event query based on the inference ensemble.

14. The system of claim 13, wherein the discriminant power of each node is inversely related to a count of child nodes edge-connected to each node.

15. The system of claim 14, wherein each parent node belongs to a predefined class and each child node belongs to a different predefined class.

16. The system of claim 13, wherein the macro-view graph is a probabilistic graph model and wherein the macro-node vote of each committee node is determined based on a weighted probability that the committee node is edge-connected to a predetermined target node.

17. The system of claim 13, wherein the received data is one or more indicators of compromise (IoC) associated with a malware attack and the event query is based on the one or more indicators of compromise (IoC).

18. The system of claim 17, wherein the response is an identifier identifying a likely malware family associated with the one or more IoCs.

19. The system of claim 17, and wherein the response is an identifier identifying a likely threat actor that instigated the malware attack.

20. The system of claim 17, wherein the response is a recommendation that a computer system be defended against one or more malware families associated with a malicious file corresponding to the one or more IoCs.

21. A system, comprising:
a processor configured to initiate operations including:
generating a graph having a node for each of a plurality of electronically generated data structures, wherein the data structures represent objects;
detecting one or more attributes of each object and generating a detector tag for each of the attributes, each detector tag represented as a child node of the node whose data structure represents the object having the attribute corresponding to the detector tag;
discovering one or more relational dependencies between one or more objects and one or more of the nodes and child nodes, each relational dependency represented by an edge;
determining a discriminant power corresponding to each edge and generating a base-view graph by pruning the graph of each child node for which the corresponding edge is less than a predetermined threshold;
determining a reference value for each child node and generating a micro-view graph by pruning the graph of each child node whose reference value is less than a predetermined value; and
generating one or more committee nodes by combining child nodes that are edge-connected to the same node, determining a macro-node vote for each committee node, and generating a macro-view graph by pruning the committee nodes whose macro-node vote is less than a predetermined threshold.

22. The system of claim 21, wherein the discriminant power is inversely related to a count of child nodes edge-connected to each node.

23. The system of claim 21, wherein the macro-view graph is a probabilistic graph model and wherein the macro-node vote of each committee node is determined based on a weighted probability that the committee node is edge-connected to a predetermined target node.

24. The system of claim 21, wherein the objects include one or more indicators of compromise (IoC) associated with a malware attack.

25. A computer program product, the computer program product comprising:
one or more computer-readable storage media and program instructions collectively stored on the one or more computer-readable storage media, the program instructions executable by a processor to cause the processor to initiate operations including:
expanding, with a processor at run-time, a set of nodes to include a node generated in response to received data corresponding to an event query;
determining a first inference of an inference ensemble by traversing a base graph generated by the processor using the set of nodes, wherein the base graph is generated to include nodes selected from the set of nodes that each have associated therewith a discriminant power that exceeds a predetermined entity threshold;
determining a second inference of the inference ensemble by traversing a micro-view graph, wherein the micro-view graph is generated to include nodes selected from the set of nodes that each have associated therewith a number of parent nodes that exceeds a predetermined reference threshold;
determining a third inference of the inference ensemble by traversing a macro-view graph, wherein the macro-view graph is generated by merging nodes from the set of nodes that are edge-connected to a common parent node into committee nodes and selecting each committee node having associated therewith a macro-node vote that exceeds a predetermined value; and
generating a response to the event query based on the inference ensemble.
